(19) United States
(12) Patent Application Publication
(10) Pub. No.: US 2002/0034370 A1
(43) Pub. Date: Mar. 21, 2002

(54) Optical fiber mirror and method for fabricating the same

(76) Inventors: Young Choon Yook, Chunju (KR); Duck Young Kim, Kwangsan-Ku (KR)

Correspondence Address: BACON & THOMAS, PLLC, 4th Floor, 625 Slaters Lane, Alexandria, VA, 22314-1176, US

(21) Appl. No.: 09/801,768

(22) Filed: Mar. 9, 2001

(30) Foreign Application Priority Data
Sep. 21, 2000 (KR) 10-2000-55422

(51) Int. Cl. G02B 6/00

(52) U.S. Cl. 385/139

(57) ABSTRACT

Disclosed is an optical fiber mirror fabricated using an assistant rod bonded to an optical fiber and adapted to increase the cross-sectional area of a metal coating formed on the optical fiber at an end portion of the optical fiber, and a method for fabricating the optical fiber mirror. An optical fiber is dipped in a metal melt in a state attached to an assistant rod, and taken out of the metal melt so that the metal is coated on the optical fiber in the form of a bulk. Accordingly, an optical fiber mirror exhibiting a superior resistance to the surrounding environment can be easily fabricated, as compared to conventional methods using no assistant rod. The optical fiber is cleaved to form an end surface, and polished at the end surface. After the polishing process, the optical fiber is attached to the assistant rod. The optical fiber is then dipped in a metal melt contained in a crucible in an atmosphere maintained at a temperature higher than the melting point of the metal, so that it is coated with the metal. The metal-coated optical fiber is then taken out of the crucible after being shaken in the metal melt. Since the sample preparation process and the metal coating process are simple, and no expensive device such as a vacuum device is used, optical fiber mirrors can be inexpensively fabricated in mass production.

### BACKGROUND OF THE INVENTION

1. Field of the Invention

The present invention relates to a technique for fabricating an optical fiber mirror necessarily used in an optical fiber interferometric sensor, and more particularly to an optical fiber mirror fabricated using an assistant rod bonded to an optical fiber and adapted to increase the cross-sectional area of a metal coating formed on the optical fiber at an end portion of the optical fiber.

2. Description of the Related Art

Optical fiber mirrors are used to reflect light in interferometric sensors.

In association with such optical fiber mirrors, there are a variety of optical fiber fabrication methods. That is, there are known a plasma-enhanced chemical vapor deposition method, an aluminum coating in vacuum method, and a sol-gel coating method. All of these methods are metal coating techniques for formulating an atmosphere capable of achieving an excellent bonding between an optical fiber and a metal.

In the plasma-enhanced chemical vapor deposition method and aluminum coating in vacuum method, metal grains are coated on the end surface of an optical fiber in the form of multilayers in a vacuum atmosphere. For this reason, it is necessary to a vacuum device. Furthermore, these methods have a drawback in that the metal coated on the end surface of the optical fiber may be easily peeled off.

The sol-gel coating method uses a chemically selective bonding. This method has a drawback in that it involves a complex sample preparing process and a complex coating process.

FIG. 1 schematically illustrates a conventional metal coating method which involves the steps of peeling off a polymer coating from an optical fiber 10, processing the optical fiber to have a flat end surface 10a of the optical fiber 10, and dipping the optical fiber 10 in a metal melt contained in a crucible, thereby coating a metal layer on the end surface 10a of the optical fiber. Since the metal denoted by the reference numeral 12 in FIG. 1 exhibits a low bonding force to the optical fiber 10, the angle of the optical fiber 10 dipped in the crucible and the speed of the optical fiber 10 removed from the crucible are important in coating the metal 12 on the end surface 10a of the optical fiber 10. For this reason, the coating of the metal 12 on the end surface 10a of the optical fiber 10 should be carried out while carefully taking into consideration the state of the metal melt contained in the crucible, the angle of the optical fiber 10 dipped in the crucible, and the removal speed of the optical fiber 10.

Practically, the metal 12 may be coated on the end surface 10a of the optical fiber in a state in which an air layer is interposed between the end surface 10a and the metal 12. For this reason, special attention should be paid to the coating of the metal 12.

### SUMMARY OF THE INVENTION

Therefore, the present invention has been made in view of the above mentioned problems, and an object of the invention is to provide a method for fabricating an optical fiber mirror, which uses a simple sample preparation process and a simple coating process without using any expensive device such as a vacuum device, thereby being capable of inexpensively fabricating optical fiber mirrors in mass production, and an optical fiber fabricated using the method.

Another object of the invention is to provide an optical fiber mirror in which a metal is coated on an optical fiber in the form of a bulk, so that there is no possibility for the metal to be peeled off due to the surrounding environment, and a method for fabricating the optical fiber mirror.

In order to accomplish these objects, the present invention provides a method for fabricating an optical fiber mirror, in which an optical fiber is dipped in a metal melt in a state attached to an assistant rod, and taken out of the metal melt so that the metal is coated on the optical fiber in the form of a bulk. Accordingly, it is possible to easily fabricate an optical fiber mirror exhibiting a superior resistance to the surrounding environment, as compared to the conventional method using no assistant rod.

In accordance with the present invention, the optical fiber is cleaved to form an end surface, and polished at the end surface. After the polishing of the end surface, the optical fiber is attached to the assistant rod. The optical fiber attached to the assistant rod is dipped in a metal melt contained in a crucible in an atmosphere maintained at a temperature higher than the melting point of the metal, so that it is coated with the metal. The metal-coated optical fiber is then taken out of the crucible after being shaken in the metal melt. Since the sample preparation process and the metal coating process are simple, and no expensive device such as a vacuum device is used, it is possible to inexpensively fabricate optical fiber mirrors in mass production.

### BRIEF DESCRIPTION OF THE DRAWINGS

The above objects, and other features and advantages of the present invention will become more apparent after a reading of the following detailed description when taken in conjunction with the drawings, in which:

FIG. 1 is a sectional view illustrating a conventional optical fiber mirror;

FIG. 2 is a view illustrating a state in which an optical fiber is attached to a fused silica glass rod in accordance with the present invention;

FIG. 3 is a view illustrating a procedure for coating a metal on the optical fiber in a crucible in accordance with the present invention;

FIG. 4 is a sectional view illustrating an optical fiber mirror fabricated in accordance with an embodiment of the present invention;

FIG. 5a is a sectional view illustrating an optical fiber mirror fabricated in accordance with another embodiment of the present invention; and

FIG. 5b is a sectional view illustrating the optical fiber mirror of FIG. 5a in a metal-coated state

### DESCRIPTION OF THE PREFERRED EMBODIMENTS

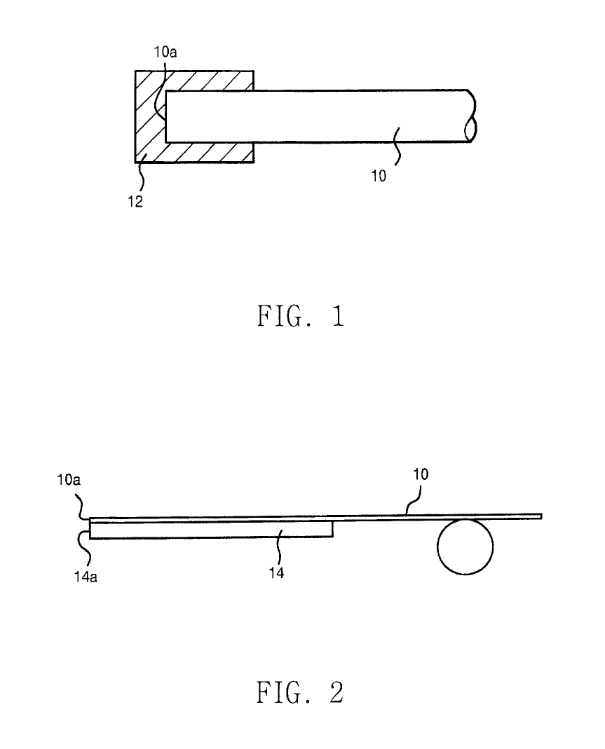

Now, the present invention will be described in detail, in conjunction with FIGS. 2 to 4.

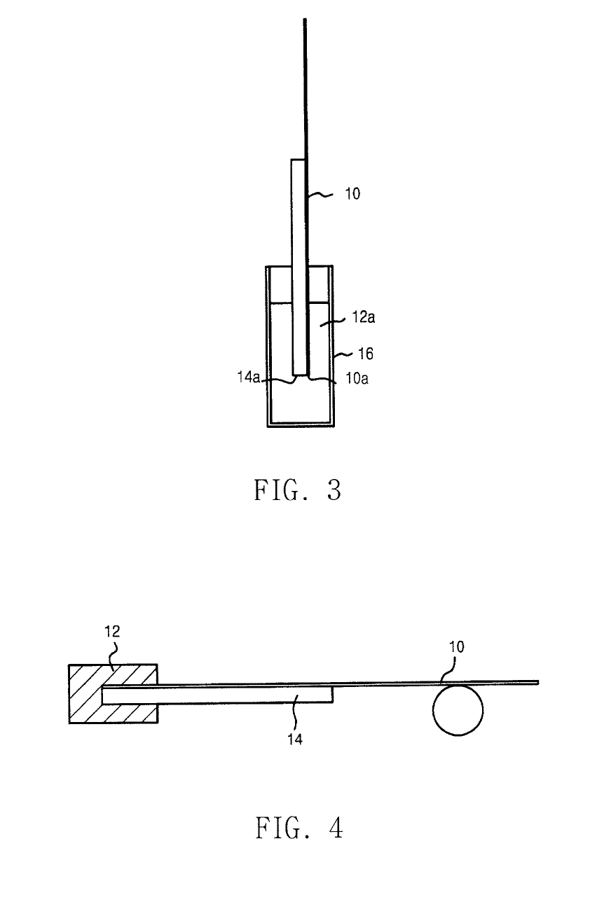

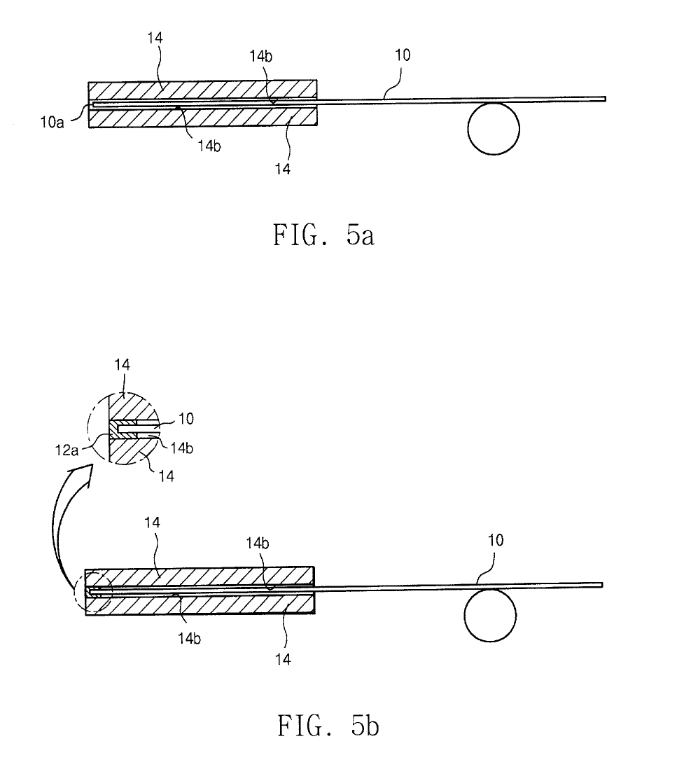

FIG. 2 illustrates a state in which an optical fiber is attached to a fused silica glass rod in accordance with the present invention. FIG. 3 illustrates a procedure for coating a metal on the optical fiber in a crucible in accordance with the present invention. FIG. 4 is a sectional view illustrating an optical fiber mirror fabricated in accordance with an embodiment of the present invention. FIG. 5a is a sectional view illustrating an optical fiber mirror fabricated in accordance with another embodiment of the present invention. FIG. 5b is a sectional view illustrating the optical fiber mirror of FIG. 5a in a metal-coated state In FIGS. 2 to 5b, reference numerals respectively corresponding to those in FIG. 1 are denoted by the same reference numerals.

Referring to FIG. 2, an optical fiber 10 is illustrated which is attached to a fused silica glass rod 14. In a process for coating a metal on the optical fiber 10, the fused silica glass rod 14 serves as an assistant rod.

In order to fabricate an optical fiber mirror according to the present invention, the optical fiber 10 to be coated with a metal 12 should have a flat end surface 10a. This may be achieved by cutting the optical fiber 10 to have a horizontal end surface 10a having an inclination of 1° or less, by use of a cleaver, and polishing the end surface 10a to have an increased flatness.

The reason why the end surface 10a of the optical fiber 10 is to be flat is to allow the optical fiber to well conduct a desired optical fiber mirror function after completion of the fabrication thereof into an optical fiber mirror and to prevent formation of an air layer.

The optical fiber 10 having the flat end surface 10a is then attached, at a side surface thereof to a side surface of the fused silica glass rod 14 facing the side surface of the optical fiber 10. The attachment of the optical fiber 10 to the fused silica glass rod 14 is achieved by arranging the end surface 10a of the optical fiber 10 to be flush with or slightly protruded from an end surface 14a of the fused silica glass rod 14, and then bonding the optical fiber 10 to the fused silica glass rod 14 using an adhesive having a melting point higher than the melting point of a metal 12 to be coated on the optical fiber 10. The fused silica glass rod 14 is adapted to increase the cross-sectional area of a metal coating formed on the optical fiber 10.

The end surface 14a of the fused silica glass rod 14 is also flat in similar to the end surface 10a of the optical fiber 10. The reason why the end surface 14a of the fused silica glass rod 14 is to be flat is the same as that associated with the optical fiber 10.

FIG. 3 schematically illustrates the state in which the optical fiber 10 prepared in the process shown in FIG. 2 is dipped in a crucible 16 contained with a metal melt 12a. The metal melt 12a is produced by maintaining the internal atmosphere of a furnace at a temperature of 50 to 150° C. preferably higher than the melting point of the metal 12, and containing the metal 12 of a solid phase in the crucible 16, and then putting the crucible 16 into a chamber of the furnace, thereby melting the solid metal 12.

The metal melt 12a contained in the crucible 16 is taken out of the chamber about 10 minutes after the metal 12 is completely melted, and is maintained at ambient temperature as it is. As a result, the metal melt 12a tends to be solidified into the solid phase metal 12. At this time, the operator dips the fused silica glass rod 14 attached with the optical fiber 10 into the metal melt 12a contained in the crucible 16 while grasping the fused silica glass rod 14 by the hand, slightly shakes the fused silica glass rod 14 in the metal melt 12a, and then taking the fused silica glass rod 14 out of the crucible 16. As a result, the metal 12 is coated on the optical fiber 10 attached to the fused silica glass rod 14. Thus, an optical fiber mirror is produced.

The angle and speed, at which the optical fiber 10 dipped into the metal melt 12a when the metal melt 12a begins to solidify after it is exposed to ambient temperature is taken out of the metal melt 12a, are important in obtaining an excellent coating quality.

The internal temperature of the furnace is limited to a temperature of 50 to 150° C. higher than the melting point of the metal 12. When the internal temperature of the furnace is maintained at a temperature less than 50° C., the metal melt 12a is solidified immediately after it is exposed to ambient temperature. On the other hand, when the internal temperature of the furnace is maintained at a temperature more than 150° C., a lengthened period of time is taken to solidify the metal melt 12a after the optical fiber 10 is taken out of the crucible 16.

FIG. 4 schematically illustrates the optical fiber 10 and fused silica glass rod 14 subjected to the process of FIG. 3. Since the fused silica glass rod 14 is used to coat the metal 12 on the optical fiber 10 in accordance with the present invention, it is possible to well coat the metal 12 and to easily fabricate an optical fiber mirror, as compared to the conventional case of FIG. 1 in which the fabrication of an optical fiber mirror is carried out without using the fused silica glass rod.

FIG. 5a illustrates another embodiment of the present invention. In accordance with this embodiment, a capillary tube portion 14b having a diameter larger than that of the optical fiber 10 is centrally formed through the fused silica glass rod 14 while extending throughout the length of the fused silica glass rod 14. The optical fiber 10 is inserted into the capillary tube portion 14b of the fused silica glass rod 14 while defining a fine gap around the outer surface thereof.

The insertion of the optical fiber 10 is carried out in such a fashion that the inner end of the optical fiber 10 inserted into the capillary tube portion 14b is not protruded beyond the end surface 14a of the fused silica glass rod 14, thereby defining a space between the inner end of the optical fiber 10 and the end surface 14a of the fused silica glass rod 14.

When the fused silica glass rod 14 is dipped into in the metal melt 12a contained in the crucible 16 under the above condition, the metal melt 12a penetrates the gap defined in the capillary tube portion 14b of the fused silica glass rod 14, thereby filling the space defined the inner end of the optical fiber 10 and the end surface 14a of the fused silica glass rod 14. Thus, the inner end of the optical fiber 10 is coated with the metal melt 12a. Thus, a desired optical fiber mirror is manufactured.

As apparent from the above description, the optical fiber mirror of the present invention is fabricated by bonding together the facing side surfaces of the optical fiber 10 and fused silica glass rod 14 respectively having the flat end surfaces 10a and 14a, and then solidifying the metal melt 12a on respective end portions of the optical fiber 10 and fused silica glass rod 14, where the flat end surfaces 10a and 14a are provided, thereby coating the metal 12 on the optical fiber 10 and fused silica glass rod 14.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

For example, although the coating of the metal 12 is achieved using the fused silica glass rod 14 attached to the optical fiber 10, an assistant rod made of a material other than that of the fused silica glass rod 14 may be used to achieve an easy coating of the metal 12 in so far as the material of the assistant rod has a melting point higher than that of the metal 12, taking into consideration that the reason why the fused silica glass rod 14 is used is that the fused silica glass rod 14 has a melting point of about 1,600° C.

In other words, the fact that the assistant rod has a melting point higher than that of the metal 12 means that a variety of metals having a melting point less than that of the assistant rod may be coated on the end portion of the optical fiber 10.

As apparent from the above description, the present invention provides a method for fabricating an optical fiber mirror, in which an optical fiber is dipped in a metal melt in a state attached to an assistant rod, and taken out of the metal melt so that the metal is coated on the optical fiber in the form of a bulk. Accordingly, it is possible to easily fabricate an optical fiber mirror and to prevent the metal coating from being peeled off due to the surrounding environment, as compared to the conventional method using no assistant rod.

In accordance with the present invention, the optical fiber is cleaved to form an end surface, and polished at the end surface. After the polishing of the end surface, the optical fiber is attached to the assistant rod. The optical fiber attached to the assistant rod is dipped in a metal melt contained in a crucible in an atmosphere maintained at a temperature higher than the melting point of the metal, so that it is coated with the metal. The metal-coated optical fiber is then taken out of the crucible after being shaken in the metal melt. Since the sample preparation process and the metal coating process are simple, and no expensive device such as a vacuum device is used, it is possible to inexpensively fabricate optical fiber mirrors in mass production.

What is claimed is:

1. An optical fiber mirror comprising:
an optical fiber having a flat end surface at an end portion thereof;
a fused silica glass rod having a flat end surface at an end portion thereof, the fused silica glass rod being bonded, at a side surface thereof, to a side surface of the optical fiber facing the side surface of the fused silica glass rod; and
a metal coating formed on the end portions of the optical fiber and fused silica glass rod in accordance with a solidification of a metal melt coated on the end portions.

2. The optical fiber mirror according to claim 1, wherein the bonding of the fused silica glass rod to the optical fiber is achieved by an adhesive having a melting point higher than that of the metal coating.

3. An optical fiber mirror comprising:
an optical fiber having a flat end surface at an end portion thereof;
a fused silica glass rod having a flat end surface at an end portion thereof, the fused silica glass rod the fused silica glass rod being provided, at a central portion thereof, with a capillary tube portion having a diameter larger than that of the optical fiber and extending throughout the length of the fused silica glass rod, the capillary tube portion serving to receive the optical fiber; and
a metal coating formed on the end portion of the optical fiber in accordance with a solidification of a metal melt coated on the end portion of the optical fiber.

4. The optical fiber mirror according to claim 3, wherein the optical fiber is received, from one end thereof, in the capillary tube portion of the fused silica glass rod while being not protruded beyond the flat end surface of the fused silica glass rod, thereby defining a space between the end of the optical fiber and the end surface of the fused silica glass rod, the space being filled with the metal melt.

5. A method for fabricating an optical fiber mirror, comprising the steps of:
cutting an optical fiber to have a horizontal end surface having an inclination of 1° or less after peeling off a polymer coating from the optical fiber, and polishing the end surface, thereby allowing the end surface to be flat;
bring a side surface of the optical fiber into contact with a side surface of an assistant rod facing the side surface of the optical fiber, and arranging the optical fiber and assistant rod to allow the end surface of the optical fiber to be flush with or slightly protruded from an end surface of the fused silica glass rod, and bonding together the optical fiber and assistant rod using an adhesive;
putting a metal of a solid phase into a crucible, and putting the crucible into a heating chamber, thereby melting the metal; and
taking the crucible, contained with the metal melt, out of the chamber, dipping the assistant rod bonded with the optical fiber into the metal melt at a point of time when the metal melt begins to solidify, shaking the assistant rod in the metal melt, and then taking the assistant rod out of the metal melt.

6. The method according to claim 5, further comprising the step of:
processing the assistant rod to allow the end surface of the assistant rod to be flat.

7. The method according to claim 5, wherein the heating chamber is maintained at an internal temperature higher than a melting point of the metal by 50 to 150° C.

8. The method according to claim 5 or 6, wherein the assistant rod is a fused silica glass rod.
